(19) United States
(12) Patent Application Publication
(10) Pub. No.: US 2025/0243571 A1
(43) Pub. Date: Jul. 31, 2025

(54) HIGH-ENTROPY ALLOY AND METHOD OF MANUFACTURING THE SAME

(71) Applicant: POSTECH RESEARCH AND BUSINESS DEVELOPMENT FOUNDATION, Pohang-si (KR)

(72) Inventors: Eun Seong KIM, Pohang-si (KR); Hyoung Seop KIM, Pohang-si (KR); Haftlang FARAHNAZ, Pohang-si (KR)

(21) Appl. No.: 18/601,066

(22) Filed: Mar. 11, 2024

(30) Foreign Application Priority Data
Jan. 31, 2024 (KR) 10-2024-0015228

(51) Int. Cl. C22C 38/10; B22F 10/28; B33Y 10/00; B33Y 80/00; C22C 33/02; C22C 38/02; C22C 38/04; C22C 38/14

(52) U.S. Cl. CPC C22C 38/105; B22F 10/28; B33Y 10/00; B33Y 80/00; C22C 33/0285; C22C 38/02; C22C 38/04; C22C 38/14; B22F 2304/10; B22F 2998/10; B22F 2999/00

(57) ABSTRACT

Provided are a high-entropy alloy and a method of manufacturing the same, and the high-entropy alloy may include: a dual-phase structure of a columnar face-centered cubic (FCC) phase and an isometric body-centered cubic (BCC) phase; a cell structure; and precipitates.

### CROSS-REFERENCE TO RELATED APPLICATION

This application claims priority to and the benefit of Korean Patent Application No. 10-2024-0015228 filed in the Korean Intellectual Property Office on Jan. 31, 2024, the entire contents of which are incorporated herein by reference.

### BACKGROUND OF THE INVENTION

### (a) Field of the Invention

The present disclosure relates to a high-entropy alloy and a method of manufacturing the same, and more particularly, to a high-entropy alloy having excellent mechanical properties by using a metal additive manufacturing process, and a method of manufacturing the same.

### (b) Description of the Related Art

A common metal alloy is formed of major elements and small amounts of alloy elements, and as alloy elements are added, an intermetallic compound is more likely to be formed, and the intermetallic compound may weaken the mechanical properties as it causes brittleness in materials.

A high-entropy alloy (HEA) is an alloy in which 5 or more various elements act as major elements and has high mixing entropy. Gibbs free energy is lowered due to high entropy, so that the intermetallic compound is not formed, and the alloy is formed of a face-centered cubic (FCC), body-centered cubic (BCC), or hexagonal close-packed (HCP) single phase having excellent ductility.

Since the high-entropy alloy has high strength and elongation rate in various fields, and also, are excellent in the properties such as high-temperature resistance and corrosion resistance, it is being actively studied as a material for recovering limitations of existing materials.

The high-entropy alloy is a multi-element alloy in which a plurality of constituent elements are alloyed at similar ratios, deviating from the concept of traditional alloys including at least one major element and a small amount of impurities. Since the high-entropy alloy has high mixing entropy in the alloy, it does not form an intermetallic compound and has a single-phase or dual-phase structure. Particularly, an FCC-based high-entropy alloy having a face centered cubic structure single phase is in the spotlight as a metal material for a cryogenic structure by a combination of excellent plastic hardening and excellent tensile strength and elongation rate at a low temperature of about 77 K.

However, though the FCC-based high-entropy alloy shows excellent tensile properties at an extremely low temperature, it shows low yield strength at room temperature. It is problematic in that the application area of the FCC-based high-entropy alloy is limited.

In order to solve the problem, recently, alloys in which the composition of the FCC-based high-entropy alloy is adjusted or to which a certain alloy element is added have been manufactured. An attempt to add a specific alloy element to adjust phase stability and induce martensitic phase transformation or use a heat treatment process to precipitate a secondary phase in an FCC matrix to improve the yield strength of the alloy is in progress. Though the alloy develops the yield strength of the alloy, brittle martensite and a precipitated intermetallic compound limit plastic deformation and decrease the excellent plastic hardening and elongation rate of the conventional FCC-based high-entropy alloy, and thus, workability which is closely related to industrialization of the high-entropy alloy is impaired.

In order to solve the problem, there is a need to implement excellent mechanical properties by an entropy alloy having a properly controlled fraction between the brittle martensite and the intermetallic compound through a manufacturing process which is not limited by workability.

A heterostructured material is a material in which two regions having different microhistological characteristics are connected intentionally, and is receiving a lot of attention as a material of a microstructure which may achieve excellent mechanical properties with a constituent material having the same components. Herein, the two regions may be a soft region (domain) and a hard region (domain).

Heterogenous deformation induced strengthening accepts a strain difference by dislocation in a boundary between the two regions. That is, geometrically necessary dislocation (GND) which is eventually formed in the boundary forms additional back dislocation, thereby improving both strength and elongation rate.

Since it was found that the heterostructured material described above may produce the geometrically necessary dislocations in a large amount to overcome a tradeoff between strength and ductility of the material, the heterostructured material is receiving a lot of attention, and a study of process for manufacturing the heterostructured material is actively in progress.

A metal 3D printing or metal additive manufacturing process is a technology of producing three-dimensional shaped parts by layering metal-based materials such as metal powder or metal filament, and an additive manufacturing process is a technology having significantly shortened process steps as compared with a conventional part working process. Among them, a direct energy deposition (DED) process is a technology of supplying metal powder to a target position and also melting it by a laser heat source to stack metal, and repeating the process to produce parts close to a three-dimensional shape.

In the present disclosure, in order to manufacture a high-entropy alloy showing excellent plastic hardening and elongation rate, a method of manufacturing a high-entropy alloy with a heterostructured material by the additive manufacturing process described above was studied, thereby completing the present disclosure.

### SUMMARY OF THE INVENTION

The present disclosure attempts to provide a high-entropy alloy which has excellent yield strength and elongation rate at room temperature by forming multiple heterostructures by forming a precipitation phase with BCC martensite, and has excellent mechanical properties at room temperature by additionally having excellent tensile strength and elongation rate by transformation-induced plasticity between deformations.

The present disclosure also attempts to provide a method of manufacturing a high-entropy alloy having the merits described above without conventional heat treatment and rigid plasticity working process, using an additive manufacturing single process of a high-entropy alloy.

An exemplary embodiment of the present disclosure provides a high-entropy alloy including: a dual-phase structure of a columnar face-centered cubic (FCC) phase and an isometric body-centered cubic (BCC) phase; a cell structure; and precipitates.

In the high-entropy alloy according to an exemplary embodiment, the cell structure may satisfy the following Equation 1:

$$2 \leq ( A - B ) \leq 10 \qquad [ Equation 1 ]$$

wherein A is a Ti content (at %) outside the cell, and
B is a Ti content (at %) inside the cell.

In the high-entropy alloy according to an exemplary embodiment, the BCC phase may be a martensite phase which is a phase formed along a dendrite solidification structure inside FCC phase grains.

In the high-entropy alloy according to an exemplary embodiment, the high-entropy alloy may include: 5 to 25 at % of Ni, 2.5 to 15.0 at % of Mn, 2.5 to 15.0 at % of Co, 0.25 to 5.0 at % of Ti, 0.25 to 5.0 at % of Si, a remainder of Fe, and other impurities, based on 100 at % of the entire high-entropy alloy.

In the high-entropy alloy according to an exemplary embodiment, the cell structure may include: 5.0 to 25.0 at % of Ni, 2.5 to 15.0 at % of Mn, 2.5 to 15.0 at % of Co, 0 to 7.5 at % of Ti, 0 to 5.0 at % of Si, a remainder of Fe, and other impurities, based on 100 at % of the entire cell structure.

In the high-entropy alloy according to an exemplary embodiment, the precipitates may include: 10.0 to 30.0 at % of Ni, 2.5 to 15.0 at % of Mn, 2.5 to 15.0 at % of Co, 10.0 to 30.0 at % of Ti, 1.0 to 15.0 at % of Si, a remainder of Fe, and other impurities, based on 100 at % of the entire precipitates.

In the high-entropy alloy according to an exemplary embodiment, the cell structure may satisfy the following Equation 2:

$$5 \leq ( C - D ) \leq 30 \qquad [ Equation 2 ]$$

wherein C is a Ni content (at %) outside the cell, and
D is a Ni content (at %) inside the cell.

In the high-entropy alloy according to an exemplary embodiment, the cell structure may satisfy the following Equation 3:

$$2 \leq ( E - F ) \leq 10 \qquad [ Equation 3 ]$$

wherein E is a Co content (at %) outside the cell, and
F is a Co content (at %) inside the cell.

In the high-entropy alloy according to an exemplary embodiment, the precipitates may satisfy the following Equation 4:

$$2 \leq ( I - J ) \leq 10 \qquad [ Equation 4 ]$$

wherein I is a Mn content (at %) outside the precipitates, and
J is a Mn content (at %) inside the precipitates.

In the high-entropy alloy according to an exemplary embodiment, the precipitates may satisfy the following Equation 5:

$$2 \leq ( K - L ) \leq 10 \qquad [ Equation 5 ]$$

wherein K is a Co content (at %) outside the precipitates, and
L is a Co content (at %) inside the precipitates.

In the high-entropy alloy according to an exemplary embodiment, the precipitates may satisfy the following Equation 6:

$$5 \leq ( M - N ) \leq 35 \qquad [ Equation 6 ]$$

wherein M is a Ti content (at %) outside the precipitates, and
N is a Ti content (at %) inside the precipitates.

In the high-entropy alloy according to an exemplary embodiment, the precipitates may satisfy the following Equation 7:

$$2 \leq ( O - P ) \leq 20 \qquad [ Equation 7 ]$$

wherein O is a Si content (at %) outside the precipitates, and
P is a Si content (at %) inside the precipitates.

In the high-entropy alloy according to an exemplary embodiment, the precipitates may be oval shaped and have a major axis length of 50 to 500 nm.

In the high-entropy alloy according to an exemplary embodiment, a precipitation phase of the precipitates is Fe₂SiTi and Ni₃Ti.

In the high-entropy alloy according to an exemplary embodiment, a phase fraction of the FCC phase is 85% or more, based on 100% of the phase fraction.

In the high-entropy alloy according to an exemplary embodiment, an absolute value of a difference in geometrically necessary dislocations (GND) between the BCC phase and the FCC phase may be 10×10¹² mm⁻² or more.

In the high-entropy alloy according to an exemplary embodiment, when tensile strain is applied to the high-entropy alloy, deformation-induced phase transformation from the FCC phase to the BCC phase may occur.

In the high-entropy alloy according to an exemplary embodiment, the high-entropy alloy may have a yield strength of 300 MPa or more.

In the high-entropy alloy according to an exemplary embodiment, the high-entropy alloy may have an ultimate tensile strength of 700 MPa or more.

Another exemplary embodiment of the present disclosure provides a method of manufacturing a high-entropy alloy including: manufacturing raw metal into alloy powder; supplying energy by irradiating the alloy powder with a laser beam to melt the alloy powder; and stacking the molten powder to manufacture an alloy, wherein the manufactured high-entropy alloy includes a double-phase structure of a columnar face-centered cubic (FCC) phase and an isometric body-centered cubic (BCC) phase, a cell structure, and precipitates.

In the method of manufacturing a high-entropy alloy according to an exemplary embodiment, the alloy powder manufactured in the manufacturing of raw metal into alloy powder may have a D50 in a range of 45 to 95 μm.

In the method of manufacturing a high-entropy alloy according to an exemplary embodiment, a volume fraction of powder particles corresponding to D40 to D60 may be 30 vol % or more, in a particle size distribution of the alloy powder manufactured in the manufacturing of raw metal into alloy powder.

In the method of manufacturing a high-entropy alloy according to an exemplary embodiment, an output of the laser beam in the supplying of energy to the alloy powder to melt the alloy powder may be 220 W or more.

In the method of manufacturing a high-entropy alloy according to an exemplary embodiment, an FCC phase matrix grown in the opposite direction of heat flow and a BCC martensite phase formed by heat history are formed in the stacking of the molten powder to manufacture an alloy.

The high-entropy alloy according to an exemplary embodiment of the present disclosure induces multiple heterostructures by forming a precipitation phase with BCC martensite without a heat treatment and rigid plasticity working which are conventional working, using additive manufacturing single working, and also forms high geometrically necessary dislocations near the BCC martensite, thereby providing a high-entropy alloy which has mechanical properties of excellent yield strength, tensile strength, and elongation rate at room temperature, and has excellent plastic hardening by deformation-induced phase transformation occurring during deformation.

The method of manufacturing a high-entropy alloy according to another exemplary embodiment of the present disclosure induces a heterostructure by forming a precipitation phase with BCC martensite using an additive manufacturing single process without performing a heat treatment and a rigid plasticity working process which are conventional processes, thereby providing a method of manufacturing a high-entropy alloy having the merits described above.

### BRIEF DESCRIPTION OF THE DRAWINGS

FIG. 1 shows SEM-EBSD results at a 20 μm-200 μm scale of a cross section viewed along a stacking direction of a high-entropy alloy according to the example of the present disclosure.

FIG. 2 is a drawing showing a particle size distribution and a particle size of alloy powder used in the example of the present disclosure.

FIG. 3 is a drawing showing a phase map and an inverse polo figure (IPF) map which were observed using SEM-EBSD of a cross section of the alloy powder used in the example of the present disclosure.

FIG. 4 shows an equilibrium phase diagram of the high-entropy alloy according to the example of the present disclosure.

FIG. 5 shows ECCI and phase map results which were observed using SEM-EBSD at a 500 nm-20 μm scale of the cross section viewed along the stacking direction of the high-entropy alloy according to the example of the present disclosure.

FIG. 6 shows EDS results which were observed using SEM-EBSD at a 500 nm-20 μm scale of the cross section viewed along the stacking direction of the high-entropy alloy according to the example of the present disclosure.

FIG. 7 shows TEM results and EDS and SAED results at a 20 nm-500 μm scale of the cross section viewed along the stacking direction of the high-entropy alloy according to the example of the present disclosure.

FIG. 8 shows SEM-EBSD results at a 500 nm-20 μm scale of a cross section viewed along an additive manufacturing direction of a high-entropy alloy according to Comparative Example 1 of the present disclosure.

FIG. 9 shows SEM-EBSD results at a 20 μm-200 μm scale of a cross section viewed along an additive manufacturing direction of a high-entropy alloy according to Comparative Example 2 of the present disclosure.

FIG. 10 shows SEM-EBSD results at a 20 μm-200 μm scale of a cross section viewed along an additive manufacturing direction of a high-entropy alloy according to Comparative Example 3 of the present disclosure.

FIG. 11 shows TEM results and EDS and SAED results at a 500 nm-20 μm scale of a cross section viewed along the ladditive manufacturing direction of the high-entropy alloy according to Comparative Example 3 of the present disclosure.

FIG. 12 is a graph showing strain and stress of high-entropy alloys according to the example and the comparative examples of the present disclosure.

FIG. 13 is a DIC image obtained at different strains of the high-entropy alloy according to the example of the present disclosure, and SEM-EBSD results at a 500 nm-200 μm scale of a cross section viewed in a stacking direction.

FIGS. 14 to 19 show results of TEM analysis of 25% strained microstructure of the example at nano-scales of 500 nm or less.

FIG. 20 is a schematic diagram of heterostructure and deformation behavior of the high-entropy alloy, which was drawn based on analysis results of the microstructure of the example.

### DETAILED DESCRIPTION OF THE EMBODIMENTS

The terms such as first, second, and third are used for describing various parts, components, areas, layers, and/or sections, but are not limited thereto. These terms are used only for distinguishing one part, component, area, layer, or section from other parts, components, areas, layers, or sections. Therefore, a first part, component, area, layer, or section described below may be mentioned as a second part, component, area, layer, or section without departing from the scope of the present disclosure.

The terminology used herein is only for mentioning a certain example, and is not intended to limit the present disclosure. Singular forms used herein also include plural forms unless otherwise stated clearly to the contrary. The meaning of “comprising” used in the specification is embodying certain characteristics, areas, integers, steps, operations, elements, and/or components, but is not excluding the presence or addition of other characteristics, areas, integers, steps, operations, elements, and/or components.

When it is mentioned that a part is “on” or “above” the other part, it means that the part is directly on or above the other part or another part may be interposed therebetween. In contrast, when it is mentioned that a part is “directly on” the other part, it means that nothing is interposed therebetween.

Though not defined otherwise, all terms including technical terms and scientific terms used herein have the same meaning as commonly understood by a person with ordinary skill in the art to which the present disclosure pertains. Terms defined in commonly used dictionaries are further interpreted as having a meaning consistent with the related technical literatures and the currently disclosed description, and unless otherwise defined, they are not interpreted as having an ideal or very formal meaning.

Hereinafter, exemplary embodiments of the present disclosure will be described in detail. However, these are suggested only as an example and the present disclosure is not limited thereby, and the present disclosure is only defined by the scope of the claims described later.

A high-entropy alloy according to an exemplary embodiment of the present disclosure may be a high-entropy alloy which includes a dual-phase structure of a face-centered cubic (FCC) phase and a body-centered cubic (BCC) phase, a cell structure, and precipitates.

The high-entropy alloy may be a quinary or higher multi-element alloy, and specifically, an alloy including Fe, Ni, Co, Mn, Ti, and Si elements.

The dual-phase structure is a structure including two main phases. The two main phases means that the two main phases have a phase fraction of 80% or more, specifically 80 to 100%, 85 to 100%, 80 to 99%, or 85 to 99%, based on 100% of the phase fraction.

The cell structure may refer to a structure surrounded by different phases or compositions. Specifically, the cell structure is composed of a double phase formed by composition separation in grains, and may be a structure formed of a different phase from other regions in a dendrite cross section confirmed by enlarging the grains.

Phases formed outside and inside the cell, or compositions outside and inside the cell may be different from each other. Herein, the phase inside may be a BCC phase, the phase outside the cell may be an FCC phase, and a difference in compositions inside and outside the cell may be formed with composition separation by supercooling. The cell structure may be confirmed by SEM.

The cell structure may be round or oval shaped, and a cell size may be 0.1 to 10 μm, 0.5 to 8 μm, 0.7 to 6 μm, or 1 to 4 μm, but is not limited thereto.

The precipitates may be in a region which is formed by separation from the cell structure and has a different composition from those inside and outside the cell structure. This is caused by Ti or Si, and specifically, may have precipitation phases of Fe₂SiTi and Ni₃Ti. The precipitates may be confirmed by lattice structure analysis through SAED.

The precipitates may be round or oval shaped and have a size of 1 to 900 nm, 10 to 800 nm, 30 to 700 nm, 50 to 500 nm, or 100 to 400 nm, based on a major axis length, but is not limited thereto. Meanwhile, in the present specification, the precipitates may be named nano-precipitates.

In an exemplary embodiment, the FCC may be formed of columnar grains, and the BCC phase may be formed of isometric grains. Thus, a first heterostructure in which two regions are formed in different shapes may be formed. The first heterostructure may be observed at 20 μm-200 μm scale. Not only yield strength but also ultimate tensile strength may be excellently shown through the first heterostructure.

Herein, the isometric grains may be defined as particles forming an alloy having an average aspect ratio of 2.0 or less, and may be formed of grains of similar size in all directions. In addition, the average aspect ratio may be specifically 0.5 or more. When a temperature gradient in a specific direction is large, they may be formed into coarse columnar grains having the average aspect ratio which does not correspond to the range. Specifically, the columnar grains refer to thin and long crystals such as a pillar.

Herein, the aspect ratio of the particles forming the alloy may be calculated by analyzing a SEM-EBSD image of a cross section of the alloy using a previously known image analysis program.

In an exemplary embodiment, the cell structure may satisfy each of the following Equations 1 to 3 independently, thereby forming a second heterostructure in which the inside and the outside of the cell have heterogeneous compositions. The second heterostructure may be observed at a 500 nm-20 μm scale. Herein, the outside of the cell may refer to a region outside the cell which is 0.1 μm or more away from a cell boundary, specifically, a region outside the cell with a distance of 0.1 to 50 μm, 0.1 to 20 μm, or 1 to 20 μm.

$$2 \leq ( A - B ) \leq 10 \qquad [ Equation 1 ]$$

wherein A is a Ti content (at %) outside the cell, and
B is a Ti content (at %) inside the cell,

$$5 \leq ( C - D ) \leq 30 \qquad [ Equation 2 ]$$

wherein C is a Ni content (at %) outside the cell, and
D is a Ni content (at %) inside the cell,

$$2.5 \leq ( E - F ) \leq 10 \qquad [ Equation 3 ]$$

wherein E is a Co content (at %) outside the cell, and
F is a Co content (at %) inside the cell.

By satisfying Equations 1 to 3, respectively or simultaneously, the second heterostructure in which the inside and the outside of the cell have heterogeneous compositions may be formed, and not only yield strength but also ultimate tensile strength may be excellently shown through the second heterostructure.

In an exemplary embodiment, the BCC phase may be a non-equilibrium martensite phase which is a phase formed along a dendrite solidification structure inside FCC phase grains. The elongation rate is secured by forming a relatively ductile FCC phase matrix as such inside the cell structure, and simultaneously heterogenous deformation induced strengthening is expressed by forming a BCC phase outside the cell structure, and thus, yield strength and ultimate tensile strength may be shown excellently.

In an exemplary embodiment, the absolute value of a difference in geometrically necessary dislocations (GND) between the BCC phase and the FCC phase may be 10×10¹² mm⁻² or more, specifically 20×10¹² mm⁻² or more, 10×10¹² to 100×10¹² mm⁻², 15×10¹² to 80×10¹² mm⁻² or 20×10¹² to 60×10¹² mm⁻².

In an exemplary embodiment, a phase fraction of the FCC phase may be 85% or more, based on 100% of the phase fraction. Specifically, the phase fraction of the FCC phase may be 87% or more, more specifically 89% or more. More specifically, the phase fraction of the FCC phase may be 95% or less. The BCC phase and the FCC phase satisfy the range described above, thereby forming a ductile FCC matrix to secure the elongation rate of the alloy, and simultaneously obtaining excellent yield strength and tensile strength properties.

When the FCC phase is outside the lower limit, the elongation rate is decreased to obtain a brittle alloy. When the FCC phase is outside the upper limit, the fraction of the BCC phase which affects strength is decreased to deteriorate yield strength and tensile strength.

In an exemplary embodiment, the precipitates may satisfy each of the following Equations 4 to 7 independently, and thus, a third heterostructure in which the inside and the outside of the precipitates have heterogeneous compositions may be formed. The third heterostructure may be observed at a 20 nm-500 nm scale. The yield strength and the ultimate tensile strength may be shown excellently through the third heterostructure.

Herein, the outside of the precipitates may refer to a region outside the precipitates which is 0.01 nm or more away from a precipitate boundary, specifically, a region outside the precipitates with a distance of 0.01 to 500 nm, 0.1 to 500 nm, 1 to 500 nm, 1 to 400 nm, 10 to 400 nm, or 20 to 300 nm.

$$2 \leq ( I - J ) \leq 10 \qquad [ Equation 4 ]$$

wherein I is a Mn content (at %) outside the precipitates, and
J is a Mn content (at %) inside the precipitates,

$$2 \leq ( K - L ) \leq 10 \qquad [ Equation 5 ]$$

wherein K is a Co content (at %) outside the precipitates, and
L is a Co content (at %) inside the precipitates,

$$5 \leq ( M - N ) \leq 35 \qquad [ Equation 6 ]$$

wherein M is a Ti content (at %) outside the precipitates, and
N is a Ti content (at %) inside the precipitates,

$$2 \leq ( O - P ) \leq 20 \qquad [ Equation 7 ]$$

wherein O is a Si content (at %) outside the precipitates, and
P is a Si content (at %) inside the precipitates.

In an exemplary embodiment, the precipitates may be oval shaped and have a major axis length of 50 to 500 nm, specifically 50 to 400 nm, 70 to 400 nm, 90 to 350 nm, or 100 to 300 nm. Herein, the major axis length of the precipitates may refer to that measured on a horizontal plane.

The precipitates satisfy the length range, whereby the high-entropy alloy may secure excellent yield strength and tensile strength.

In an exemplary embodiment, a precipitation phase of the precipitates may be Fe₂SiTi and Ni₃Ti. The precipitates are precipitated as two precipitation phases, whereby the high-entropy alloy may secure excellent yield strength and tensile strength.

In an exemplary embodiment, the high-entropy alloy of the present disclosure may include: 5 to 25 at % of Ni, 2.5 to 15.0 at % of Mn, 2.5 to 15.0 at % of Co, 0.25 to 5.0 at % of Ti, 0.25 to 5.0 at % of Si, a remainder of Fe, and other impurities, based on 100 at % of the entire high-entropy alloy. Hereinafter, the reason for limiting the composition of the high-entropy alloy will be described.

### Ni: 5 to 25 at %

Nickel (Ni) is an element which serves to stabilize the FCC phase. The nickel may be included at 5 to 25 at %, specifically 7.5 to 20.0 at %.

When the content of nickel is outside the upper limit, a ductile FCC phase is formed to deteriorate yield strength and tensile strength. When the content of nickel is outside the lower limit, the BCC phase is stabilized to suppress formation of the FCC phase, so that brittleness of the alloy is shown.

### Mn: 2.5 to 15 at %

Manganese (Mn) is an element which serves to stabilize the FCC phase. The manganese may be included at 2.5 to 15 at %, specifically 5.0 to 12.5 at %.

When the content of manganese is outside the upper limit, a ductile FCC phase is formed to deteriorate yield strength and tensile strength. When the content of manganese is outside the lower limit, the BCC phase is stabilized to suppress formation of the FCC phase, so that brittleness of the alloy is shown.

### Co: 2.5 to 15 at %

Cobalt (Co) is an element which serves to stabilize the FCC phase. The cobalt may be included at 2.5 to 15 at %, specifically 5.0 to 12.5 at %.

When the content of cobalt is outside the upper limit, a ductile FCC phase is formed to deteriorate yield strength and tensile strength. When the content of cobalt is outside the lower limit, the BCC phase is stabilized to suppress formation of the FCC phase, so that brittleness of the alloy is shown.

### Ti: 0.25 to 5.0 at %

Titanium (Ti) is an element which serves to form nanoprecipitates. The titanium (Ti) may be included at 0.25 to 5.0 at %, specifically 1.0 to 4.0 at %.

When the content of titanium is outside the upper limit, a brittle intermetallic compound other than the nanoprecipitates described later is formed. When the content of titanium is outside the lower limit, the nanoprecipitates which improves yield strength are not formed.

### Si: 0.25 to 5.0 at %

Silicon (Si) is an element which forms nanoprecipitates. The silicon (Si) may be included at 0.25 to 5.0 at %, specifically 1.0 to 3.0 at %.

When the content of silicon is outside the upper limit, a brittle intermetallic compound other than the nanoprecipitates described later is formed. When the content of silicon is outside the lower limit, the nanoprecipitates which improves yield strength are not formed.

### Fe: 60.0 to 75.0 at %

Iron (Fe) is a major element and solid-solubilizes other alloy elements, and is an element which serves to form a matrix of an FCC or BCC structure and martensite. The iron may be included at 60 to 75.0 at %, specifically 62.5 to 70.5 at %.

When the content of iron is outside the upper limit, the BCC phase is stabilized to suppress formation of the FCC phase, so that brittleness of the alloy is shown. When the content of iron is outside the lower limit, a brittle intermetallic compound is formed.

In addition, the high-entropy alloy may include inevitable impurities. The inevitable impurities refer to impurities which are inevitably incorporated in a steel making process and a manufacturing process of a high-entropy alloy. Since the inevitable impurities are widely known in the art, the detailed description thereof will be omitted. Addition of elements other than the alloy components described in an exemplary embodiment of the present disclosure is not excluded, and various elements may be included within a range which does not impair the technical idea of the present disclosure. When an additional element is further included, it is included by replacing Fe as a remainder.

In an exemplary embodiment, the cell structure of the high-entropy alloy of the present disclosure may include: 5.0 to 25.0 at % of Ni, 2.5 to 15.0 at % of Mn, 2.5 to 15.0 at % of Co, 0 to 7.5 at % of Ti, 0 to 5.0 at % of Si, a remainder of Fe, and other impurities, based on 100 at % of the entire cell structure. The inside of the cell structure has a different composition from the outside of the cell, thereby forming a heterostructure, and the high-entropy alloy may secure excellent yield strength and tensile strength.

Hereinafter, the detailed reason for limiting the cell structure composition will be described.

### Ni: 5 to 25 at %

Nickel (Ni) is an element which serves to stabilize the FCC phase. The nickel may be included at 5 to 25 at %, specifically 7.5 to 20.0 at %.

Ni which is an FCC phase stabilization element inside the cell may be insufficiently solidified due to elemental segregation occurring early in solidification. Thus, the inside of the cell may be rapidly transformed into a BCC martensite phase due to low FCC stability, and on the contrary, the outside of the cell abundant in Ni has higher FCC phase stability than the inside of the cell structure and may be solidified into the FCC phase.

### Mn: 2.5 to 15 at %

Manganese (Mn) is an element which serves to stabilize the FCC phase. The manganese may be included at 2.5 to 15 at %, specifically 5.0 to 12.5 at %.

Mn which is an FCC phase stabilization element inside the cell may be insufficiently solidified due to elemental segregation occurring early in solidification. Thus, the inside of the cell may be rapidly transformed into a BCC martensite phase due to low FCC stability, and on the contrary, the outside of the cell abundant in Mn has higher FCC phase stability than the inside of the cell structure and may be solidified into the FCC phase.

### Co: 2.5 to 15 at %

Cobalt (Co) is an element which serves to stabilize the FCC phase. The cobalt may be included at 2.5 to 15 at %, specifically 5.0 to 12.5 at %.

### Ti: 0 to 7.5 at %

Titanium (Ti) is an element which serves to form nanoprecipitates. The titanium (Ti) may be included at 0 to 7.5 at %, specifically 0.25 to 5.0 at % or 1.0 to 4.0 at %.

Like Ni or Mn which are elementally segregated, Ti having a higher melting point is significantly elementally segregated and may be observed outside the cell.

### Si: 0 to 5.0 at %

Silicon (Si) is an element which forms nanoprecipitates. The silicon (Si) may be included at 0 to 5.0 at %, specifically 1.0 to 3.0 at %.

Like Ni or Mn which are elementally segregated, Si which is a more non-metallic element is also significantly elementally segregated and may be observed outside the cell.

### Fe: 60.0 to 75.0 at %

Iron (Fe) is a major element and solid-solubilizes other alloy elements, and is an element which serves to form a matrix of an FCC or BCC structure and martensite. The iron may be included at 60 to 75.0 at %, specifically 62.5 to 70.5 at %.

In addition, the cell structure may include inevitable impurities. The inevitable impurities refer to impurities which are inevitably incorporated in a steel making process and a manufacturing process of a high-entropy alloy. Since the inevitable impurities are widely known in the art, the detailed description thereof will be omitted. Addition of elements other than the alloy components described in an exemplary embodiment of the present disclosure is not excluded, and various elements may be included within a range which does not impair the technical idea of the present disclosure. When an additional element is further included, it is included by replacing Fe as a remainder.

In an exemplary embodiment, the precipitates may include: 10.0 to 30.0 at % of Ni, 2.5 to 15.0 at % of Mn, 2.5 to 15.0 at % of Co, 10.0 to 30.0 at % of Ti, 1.0 to 15.0 at % of Si, a remainder of Fe, and other impurities, based on 100 at % of the entire precipitates. Hereinafter, the reason for limiting the composition of the precipitates will be described.

### Ni: 10.0 to 30.0 at %

The precipitates may include 10.0 to 30.0 at % of nickel (Ni). Specifically, the nickel may be included at 17.5 to 27.5 at %.

### Mn: 2.5 to 15.0 at %

The precipitates may include 2.5 to 15.0 at % of manganese (Mn). Specifically, the manganese may be included at 4.5 to 12.5 at %.

### Co: 2.5 to 15.0 at %

The precipitates may include 2.5 to 15.0 at % of cobalt (Co). Specifically, the cobalt (Co) may be included at 4.5 to 12.5 at %.

### Ti: 10.0 to 30.0 at %

The precipitates may include 10.0 to 30.0 at % of titanium (Ti). Specifically, the titanium may be included at 17.5 to 27.5 at %.

### Si: 1.0 to 15.0 at %

The precipitates may include 1.0 to 15.0 at % of silicon (Si). Specifically, the silicon (Si) may be included at 2.5 to 12.5 at %.

### Fe: 10.0 to 60.0 at %

The precipitates may include 10.0 to 60.0 at % of iron (Fe). Specifically, the iron (Fe) may be included at 20.0 to 50.0 at %.

In addition, the precipitates may include inevitable impurities. The inevitable impurities refer to impurities which are inevitably incorporated in a steel making process and a manufacturing process of a high-entropy alloy. Since the inevitable impurities are widely known in the art, the detailed description thereof will be omitted. Addition of elements other than the alloy components described in an exemplary embodiment of the present disclosure is not excluded, and various elements may be included within a range which does not impair the technical idea of the present disclosure. When an additional element is further included, it is included by replacing Fe as a remainder.

In an exemplary embodiment, when tensile strain is applied to the high-entropy alloy, the FCC phase may undergo deformation-induced phase transformation into the BCC phase. Specifically, as the tensile strain is applied, the high-entropy alloy has an improved strain hardening rate due to a transformation-induced plasticity (TRIP) effect, so that excellent tensile strength and elongation rate may be secured.

In an exemplary embodiment, the high-entropy alloy is an alloy having both excellent yield strength and tensile strength in a range of 290 to 310 K which is room temperature, specifically 295 to 300 K.

In an exemplary embodiment, the yield strength may be 300 MPa or more. Specifically, the yield strength may be 320 MPa, 340 MPa, 360 MPa, 380 MPa, or 400 MPa or more.

In an exemplary embodiment, the high-entropy alloy may have an ultimate tensile strength of 700 MPa or more. Specifically, the tensile strength may be 800 MPa, 900 MPa, 1000 MPa, 1010 MPa, or 1020 MPa or more.

In an exemplary embodiment, the uniform elongation rate may be 20% or more. Specifically, the uniform elongation rate may be 22% or more, 24% or more, 26% or more, 28% or more, or 30% or more.

In an exemplary embodiment, the total elongation rate may be 30% or more. Specifically, the total elongation rate may be 32% or more, 34% or more, 36% or more, 38% or more, 40% or more, 42% or more, 44% or more, or 46% to 100%.

A method of manufacturing a high-entropy alloy according to another exemplary embodiment of the present disclosure may include: manufacturing raw metal into alloy powder; supplying energy to the alloy powder to melt the alloy powder; and stacking the molten alloy powder to manufacture an alloy. Herein, the manufactured high-entropy alloy may include the constitution and the characteristics of the high-entropy alloy described above.

The manufacturing of raw metal into alloy powder may include charging prepared raw metal. Since the detailed description of the raw metal is described in detail in the high-entropy alloy described above, the high-entropy alloy may be referred in a range of non-contradiction.

The manufacturing of raw metal into alloy powder may be performed by one method of gas atomization, ultrasound usage, and plasma usage. The alloy powder may be formed with a size and a particle size distribution which may flow in a metal additive manufacturing process.

The gas atomization may use inert gas known to a person skilled in the art, and the inert gas may be specifically helium, neon, argon, krypton, or xenon, but is not limited thereto.

An appropriate powder particle size distribution may be properly changed by a metal additive manufacturing process method. Specifically, in direct energy deposition (DED) during the metal additive manufacturing process, a volume fraction of powder particles corresponding to D40 to D60 in the powder particle size distribution may be 30 vol % or more, specifically 30-70 vol % or 35-60 vol %. This means that the particle size distribution of powder is not irregular and the particle sizes are concentrated around the average.

Herein, the particle size of powder may be D10 in a range of 30-50 μm, D50 in a range of 45-95 μm, and D90 in a range of 130-170 μm.

When it is outside the powder particle size distribution range and the powder particle size range, clogging of powders in a nozzle, cracks, and pores may occur during manufacture of alloy using a metal additive manufacturing process.

In an exemplary embodiment, the energy in the supplying energy to the alloy powder to melt the alloy powder may be one or more selected from laser beam, electron beam, and plasma, but is not necessarily limited thereto, and any energy source may be used as long as materials may be melted by supplying the energy.

The supplying of energy to alloy powder to melt the alloy powder may be specifically performed by a method of irradiating a laser beam. An output of the laser beam may be 220 watt (W) or more, and when the laser beam output satisfies the range, the raw metals may be all melted, and thus, solidification may be performed without porous defects. However, when the laser beam output is less than 220 watt (W), the raw metal is not completely melted to manufacture an alloy having porous defects.

In an exemplary embodiment, in the stacking of the melted alloy powder to manufacture an alloy, the stacking may be performed sequentially.

In an exemplary embodiment, in the stacking of the melted alloy powder to manufacture an alloy, the stacking may be performed in real time by irradiating the high power laser beam described above and also supplying metal powder. Specifically, the metal powder is supplied to a target position and also stacked by melting with a laser heat source, using a direct energy deposition (DED) process, and the process is repeated to manufacture the alloy.

In an exemplary embodiment, in the stacking of the melted alloy powder to manufacture an alloy, an FCC phase matrix grown in the opposite direction of a heat flow and a BCC martensite phase formed by heat history may be formed.

The high-entropy alloy manufactured by the method of manufacturing a high-entropy alloy described above may show the excellent effects described above by including the structure, the composition, and the like of the high-entropy alloy described above.

Hereinafter, the preferred examples and comparative examples of the present disclosure will be described. However, the following examples are only a preferred example of the present disclosure, and the present disclosure is not limited to the following examples.

High-entropy alloy and manufacturing method thereof

### EXAMPLE

Fe, Ni, Co, Mn, Ti, and Si metals having a purity of 99.95% or more were prepared, and weighed at a mixing ratio of 65 at % of Fe, 15 at % of Ni, 8 at % of Co, 8 at % of Mn, 3 at % of Ti, and 1 at % of Si to manufacture alloy powder by gas atomization under an argon atmosphere.

Thereafter, the prepared alloy powder was charged into a direct energy deposition (DED) device (MX-LAB, InssTek), and then an alloy block having width×length×height of 7 mm×30 mm×10 mm was manufactured with a laser output of 220 W, a supply speed of 2.75 g/min, a laser scan speed of 850 mm/min, and a hatch spacing of 0.3 mm.

### Comparative Example 1

Fe, Ni, Co, Mn, Ti, and Si metals having a purity of 99.95% or more were prepared, and weighed at a mixing ratio of 65 at % of Fe, 15 at % of Ni, 8 at % of Co, 8 at % of Mn, 3 at % of Ti, and 1 at % of Si.

Thereafter, the prepared raw metal was charged into a zirconia crucible and melted by heating to 1,550° C., a rectangular shaped alloy ingot of a thickness of 7.8 mm, a width of 150 g, and a length of 80 mm was cast using a mold, and annealing was performed at a temperature of 900° C. for 10 minutes for homogenization and recrystallization.

### Comparative Example 2

An alloy was manufactured in the same manner as in Comparative Example 1, except that Co, Cr, Fe, Mn, and Ni metals having a purity of 99.95% or more were prepared and weighed at a mixing ratio of 20 at % of Co, 20 at % of Cr, 20 at % of Fe, 20 at % of Mn, and 20 at % of Ni.

### Comparative Example 3

An alloy was manufactured in the same manner as in the example, except that Co, Cr, Fe, Mn, and Ni metals having a purity of 99.95% or more were prepared and weighed at a mixing ratio of 20 at % of Co, 20 at % of Cr, 20 at % of Fe, 20 at % of Mn, and 20 at % of Ni.

### Experimental Example 1: Confirmation of Particle Size Distribution and Cross Section of Alloy Powder

The particle size distribution and the cross section of the Fe₆₅Ni₁₅Co₈Mn₈Ti₃Si (at %, configuration entropy ΔS=1.12 R, R: gas constant) alloy powder used in the examples were confirmed.

### (1) Confirmation of Particle Size Distribution of Alloy Powder

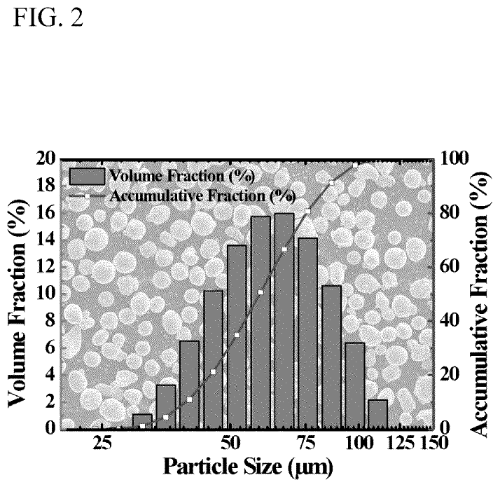

A laser particle size analyzer (Mastersizer 3000) was used for measuring the size and the particle size distribution of powder particles, and the particle size distribution and the particle size are shown in FIG. 2.

Referring to FIG. 2, D10, D50, and D90 were confirmed to be 44.7 μm, 66.5 μm, and 96.5 μm, respectively, and the average particle size was confirmed to be 66 μm or less. In addition, the volume fraction of the powder particles corresponding to D40 to D60 was confirmed to be 40 vol %. This corresponds to the particle size and the particle size distribution appropriate for the metal additive manufacturing process by direct energy deposition.

### (2) Confirmation of Cross Section of Alloy Powder

The microstructure of the cross section of the alloy powder was observed. This was performed using electron backscatter diffraction (EBSD, Philips, XL30S, 25 kV, step size=50 nm) analysis. Low EBSD data was evaluated using an Orientation Imaging Microscope (OIM) software (TSL-OIM analysis, ver. 7).

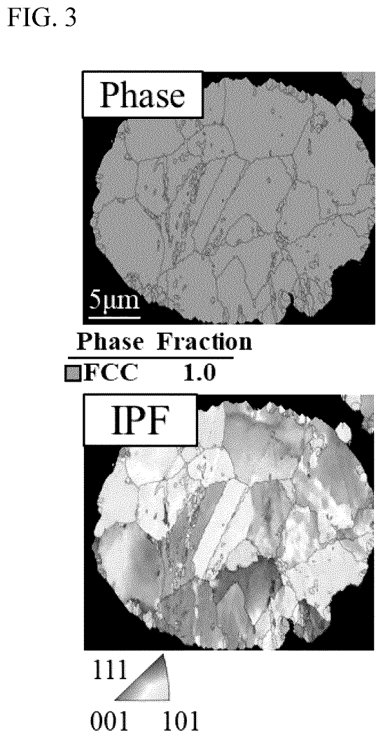

In FIG. 3, a phase map and an inverse polo figure (IPF), as scanning electron microscope-electron backscatter diffraction (SEM-EBSD) results of the cross section of the high-entropy alloy powder are shown.

Referring to FIG. 3, it was confirmed that the Fe₆₅Ni₁₅Co₈Mn₈Ti₃Si alloy powder was a face-centered cubic (FCC) structure single phase, and was manufactured into a spherical shape without cracks or pores.

### Experimental Example 2: Equilibrium Phase Diagram Analysis of High-Entropy Alloy

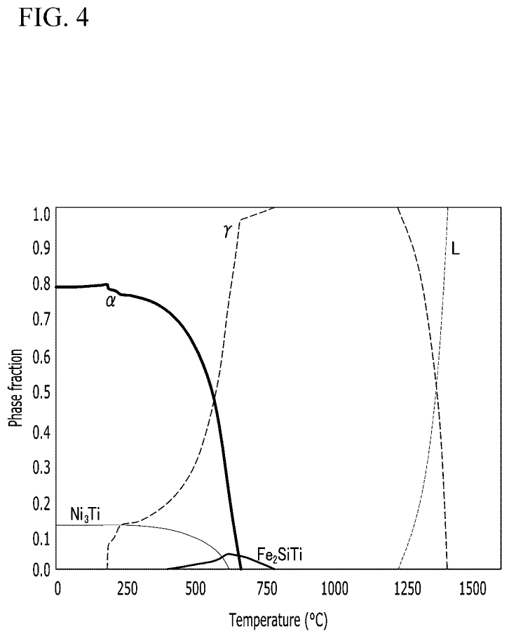

FIG. 4 shows an equilibrium phase diagram of the high-entropy alloy according to the example of the present disclosure. The equilibrium phase diagram was calculated by a Thermo-Calc software which is a thermodynamic calculation program.

In FIG. 4, a refers to a BCC phase, y refers to an FCC phase, and L refers to a liquid.

Thus, it was confirmed that the FCC phase in the present disclosure existed as a metastable phase at a high temperature, and the BCC phase existed as a significant fraction of a stable phase at a temperature of about 700° C. or lower. In addition, Fe₂SiTi and Ni₃Ti type phases were precipitated as the precipitation phase.

### Experimental Example 3: Analysis of Microstructure of High-Entropy Alloy

First, a sample was sectioned and metallurgically polished using 0.25 μm colloidal silica, and the phase constitution of the high-entropy alloy was confirmed using a Synchrotron X-ray diffractor (XRD, Si (111) double crystal monochromator of wavelength: 1.5402 Å, scan speed: 0.6°/min, 2θ: 30°-100°, step size: 0.02). A diffraction pattern was defected using an Oxford X2000 scintillation detector. The microstructure was observed using a field emission scanning electron microscope (FE-SEM, JEOL JSM-7100 F, 20 kV), electron channeling contrast imaging (ECCI), electron backscatter diffraction (EBSD, Philips, XL30S, 25 kV, step size=50 nm), and transmission Kikuchi diffraction (TKD, JEOL JSM-7900 F, 20 keV, step size=15 nm) analysis. The low EBSD data was evaluated using an orientation imaging microscope (OIM) software (TSL-OIM analysis, ver. 7). Analysis of high resolution TEM characteristics for a sample manufactured with a focused ion beam (FIB, FEI Helios Nanolab 650i) was performed using a high resolution transmission electron microscope (JEOL2100 F, Japan) at an acceleration voltage of 200 keV. An elemental distribution was further characterized by FE-SEM and TEM equipped with energy-dispersive X-ray spectroscopy (EDS).

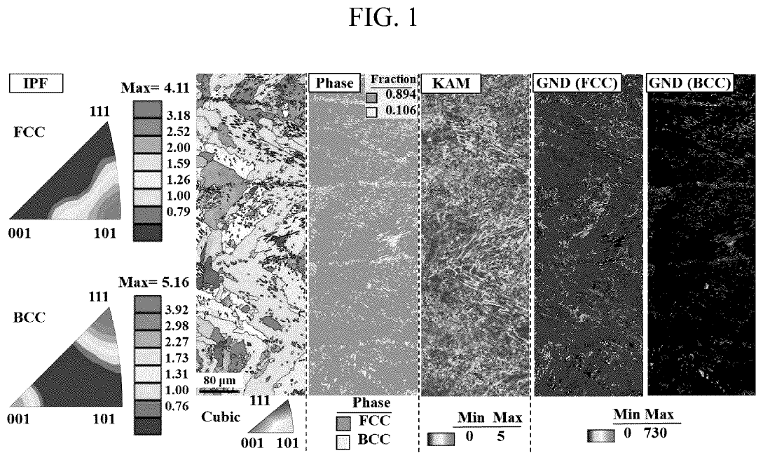

FIGS. 1 and 5 to 12 show the results of observing the microstructures of the high-entropy alloys manufactured according to the example and the comparative examples of the present disclosure using SEM-EBSD. The detailed description thereof will be described later.

(1) Analysis of Microstructure at 20 μm-200 μm Scale

FIG. 1 shows SEM-EBSD results at a 20 μm-200 μm scale of a cross section viewed along a stacking direction of the example.

Referring to FIG. 1, it was confirmed to have a dual-phase structure of an FCC phase and a BCC phase (martensite). Specifically, it was confirmed to be composed of a columnar FCC phase and a small and uniformly distributed BCC phase to show a first heterostructure.

As a result of IPF map, in the FCC, grains grew into columnar grains in the opposite direction of maximum heat flow along an additive manufacturing direction, and in the BCC martensite, grains were formed into isometric grains along a dendrite solidification structure inside FCC phase grains, not in the grain boundary. At this time, the alloy being composed of isometric grains may be defined as particles forming the alloy having an average aspect ratio of 2.0 or less, and when the average aspect ratio does not correspond to the range, it is considered that columnar grain is formed. Herein, the aspect ratio of the particles forming the alloy may be calculated by analyzing an image of the cross section of the alloy using a previously known image analysis program.

A KAM value is a value which relatively shows a degree of orientation deviation inside the metal material, and allows a deformation level to be compared. In a KAM map, since a thermal deformation of about 2% was caused due to a rapid solidification speed, a high KAM value was observed along a solidification direction, and in particular, martensitic phase transformation causing crystal lattice distortion occurred, and thus, relative deformation was involved near the BCC martensite.

In the geometrically necessary dislocation (GND) MAP according to each phase, in FCC, high GND (22.9×10¹² mm⁻²) was observed near the BCC martensite, and was a dislocation involved when the BCC martensite was formed during the metal additive manufacturing process. Likewise, the BCC martensite formed from a metastable FCC phase by a heat gradient formed during the process involved high deformation and had a significantly high GND (44.2×10¹² mm⁻²).

That is, it was confirmed in the example that the FCC and the BCC had different phase shapes formed into columnar grains and isometric grains, respectively, had different phase deformation degrees, and had different GND, so that a heterostructure existed at a 20 μm-200 μm scale.

### COMPARATIVE EXAMPLES

However, as a result of observing the cross sections of the alloys manufactured in Comparative Example 2 and Comparative Example 3 of the present disclosure, no heterostructure existed.

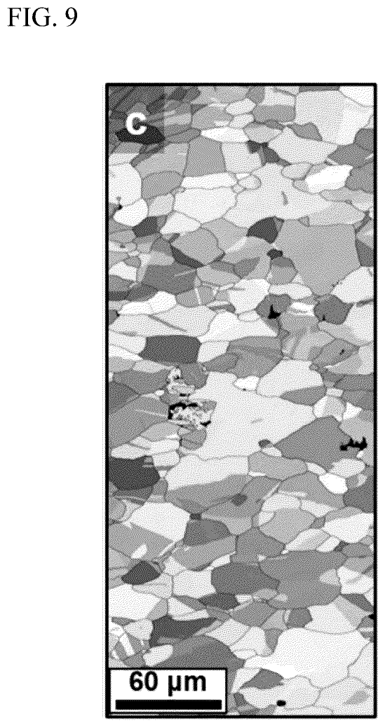

FIG. 9 shows SEM-EBSD results of Comparative Example 2 at a 20 μm-200 μm scale. Referring to FIG. 9, it was confirmed that Comparative Example 2 was formed into a single FCC phase, and any region having a different composition was not found.

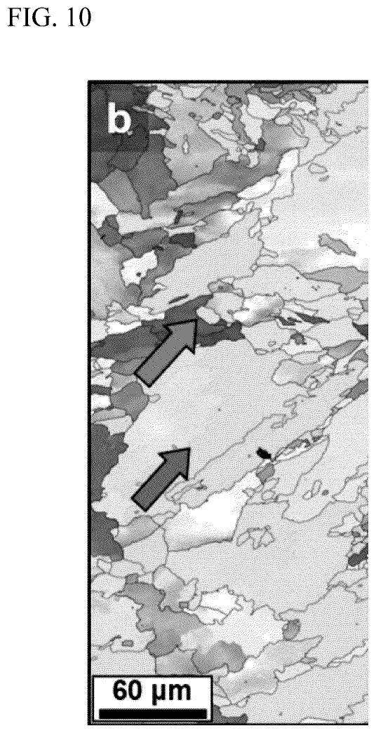

FIG. 10 shows SEM-EBSD results of Comparative Example 3 at a 20 μm-200 μm scale. Referring to FIG. 10, it was confirmed that Comparative Example 3 was formed into a single FCC phase, and a region having a different composition was not found. They were composed of a structure of large grains (arrow positioned below the other arrow) and small grains (arrow positioned above the other arrow) due to complicated heat history, but both grains were formed of the same phase and the same composition.

That is, in the comparative examples, it was confirmed that the heterostructure as in the example did not exist.

(2) Analysis of Microstructure at 500 nm-20 μm Scale

### EXAMPLE

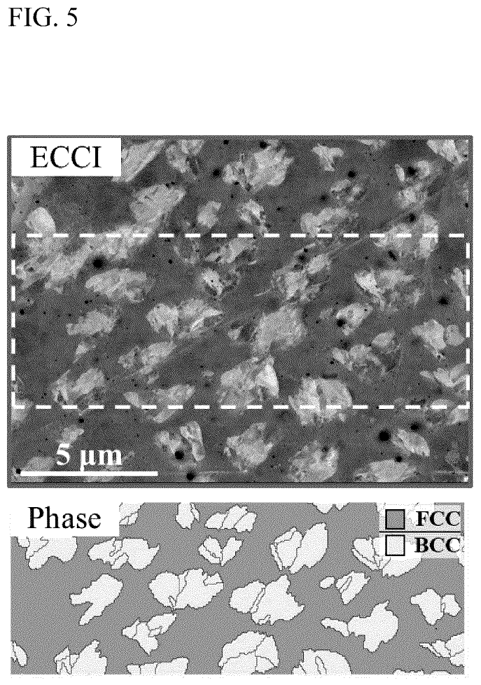

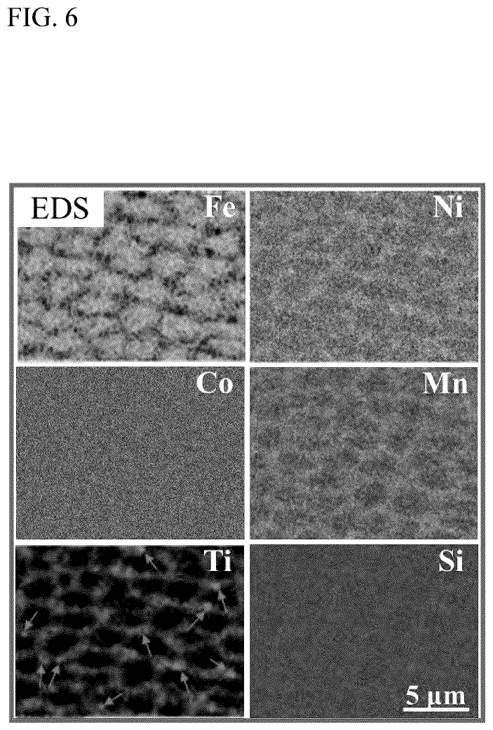

FIGS. 5 and 6 show EDS, ECCI, and phase map result at 500 nm-20 μm scale of the cross section viewed along a stacking direction, in the high-entropy alloy manufactured by a direct energy deposition process according to the example of the present disclosure. Heterogeneities of the composition and the phase were confirmed.

Referring to FIG. 5, as a result of electron channeling contrast images (ECCI), heterogeneous contrast was significantly observed. A cell structure due to a rapid solidification speed of the metal additive manufacturing process was formed inside the grains. It was confirmed to have a dual-phase structure of a sub-micro scale was confirmed by the phase map, and specifically, it was observed that the inside of the cell structure was formed into BCC, and the outside of the cell was formed into FCC.

Referring to FIG. 6, as a result of EDS analysis of a heterogeneous dual-phase structure, Mn and Ni which are FCC phase stabilization elements inside the cell were insufficiently solidified due to elemental segregation occurring early in solidification, resulting in rapid transformation of the inside of the cell into a BCC martensite phase due to its low FCC stability, and on the contrary, it was confirmed that the outside of the cell abundant in Mn and Ni had higher FCC phase stability than the inside of the cell structure and was solidified into an FCC phase. In addition, Ti having a higher melting point was significantly elementally segregated and observed outside the cell. In addition, Si was mainly observed in the precipitation phased position. Specifically, compositions as in the following Table 1 were shown.

TABLE 1

| unit: at % | | | | | | | |
|---|---|---|---|---|---|---|---|
| Alloy | | Inside cell | | | Outside cell | | |
| powder | | Mini- | Aver- | Maxi- | Mini- | Aver- | Maxi- |
| composition | | mum | age | mum | mum | age | mum |
| Fe | 65 | 60 | 67 | 74 | 46 | 53 | 60 |
| Ni | 15 | 10 | 15 | 20 | 15 | 20 | 25 |
| Mn | 8 | 5 | 7.5 | 10 | 8 | 10.5 | 13 |
| Co | 8 | 5 | 7.5 | 10 | 8 | 10.5 | 13 |
| Ti | 3 | 0 | 2.5 | 5 | 3 | 5.5 | 8 |
| Si | 1 | 0 | 0.5 | 1 | 0 | 0.5 | 1 |
| Total | 100 | 80 | 100 | 120 | 80 | 100 | 120 |

As confirmed in Table 1, a Ni content inside the cell was 15 at %, which was lower than the content outside the cell of 20 at %, and a Mn content inside the cell was 7.5 at %, which was lower than the content outside the cell of 10.5 at %. In addition, a Co content inside the cell was 7.5 at %, which was lower than the content outside the cell of 10.5 at %. Meanwhile, a Ti content inside the cell was 2.5 at %, which was lower than the content outside the cell of 5.5 at %, and a Si content was shown to be lower than 1 at % both inside and outside the cell and most of Si contributed to precipitate formation.

Specifically, the following was confirmed:

(A−B)=3.0
wherein A is a Ti content (at %) outside the cell, and
B is a Ti content (at %) inside the cell,

(C−D)=5.0
wherein C is a Ni content (at %) outside the cell, and
D is a Ni content (at %) inside the cell,

(E−F)=3.0
wherein E is a Co content (at %) outside the cell, and
F is a Co content (at %) inside the cell.

That is, it was confirmed that the compositions inside and outside the cell were different and a heterostructure existed at a 500 nm-20 μm scale.

### Comparative Example

However, as a result of observing the cross sections of the alloys according to Comparative Examples 1 and 3, there was no heterostructure.

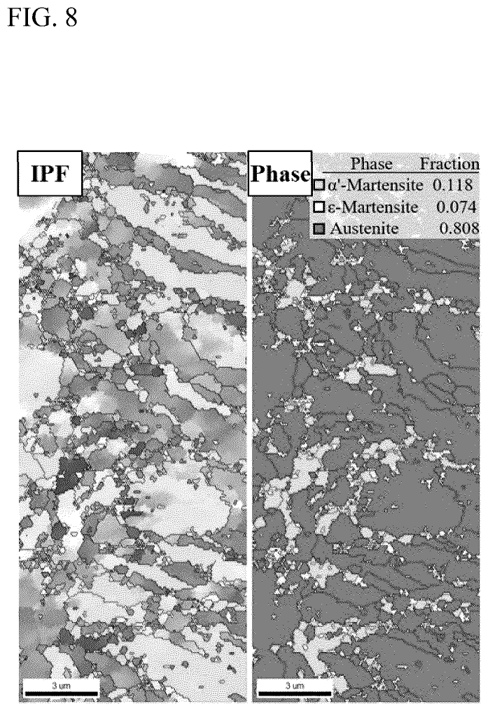

FIG. 8 shows SEM-EBSD results of Comparative Example 1 at a 500 nm-20 μm scale. A heat treatment was performed at 900° C. for 10 minutes to complete recrystallization. Referring to FIG. 8, all phases of grains were formed into isometric grains, and HCP martensite and BCC martensite were formed in the grain boundary, not inside the FCC matrix. Any difference between compositions inside and outside the cell was not confirmed.

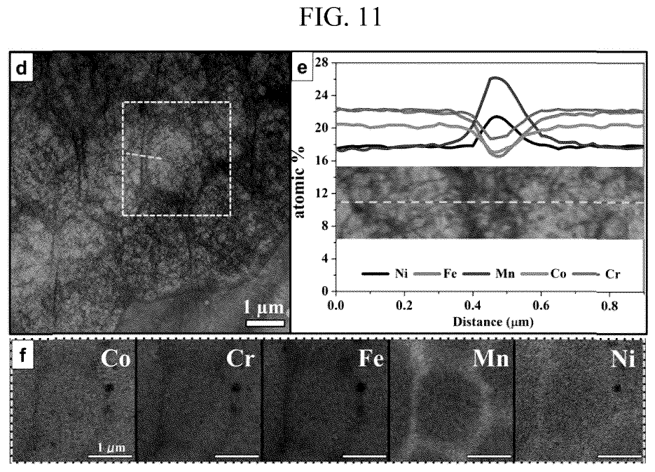

FIG. 11 shows TEM results and EDS and SAED results at a 500 nm-20 μm scale of a cross section viewed along the additive manufacturing direction of the high-entropy alloy according to Comparative Example 3 of the present disclosure. Since it was manufactured by the same manufacturing process, a specific structure by a rapid cooling rate which is the characteristic of metal additive manufacture was formed, but it was formed of the same phase and there was only minor composition segregation. A degree of composition segregation is as shown in the following Table 2.

TABLE 2

| unit: at % | | | | | Outside specific |
|---|---|---|---|---|---|
| Alloy powder | | Inside specific structure | | | structure |
| composition | | Minimum | Average | Maximum | Average |
| Fe | 20 | 16 | 18 | 20 | 22 |
| Ni | 20 | 18 | 20 | 22 | 18 |
| Mn | 20 | 20 | 23 | 26 | 18 |
| Co | 20 | 16.5 | 18 | 19.5 | 20 |
| Cr | 20 | 18.5 | 21 | 23.5 | 22 |
| Total | 100 | 89 | 100 | 111 | 100 |

(C*−D*)=2.0
wherein C* is a Ni content (at %) outside the specific structure, and
D* is a Ni content (at %) inside the specific structure,

(E*−F*)=2.0
wherein E* is a Co content (at %) outside the specific structure, and
F* is a Co content (at %) inside the specific structure.

That is, in the comparative examples, a heterostructure composed of a different phase as in the example did not exist and any significant composition segregation as in the example was not confirmed.

(3) Analysis of Microstructure at 20 nm-500 nm Scale

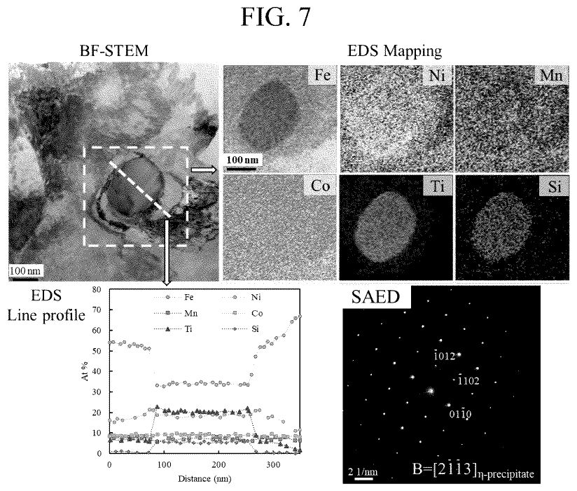

FIG. 7 shows TEM results and EDS and SAED results at a 20 nm-500 μm scale of the cross section viewed along the stacking direction of the example. Heterogeneity of a composition phase which was difficult to observe at a 20 μm-200 μm scale and a 500 nm-20 μm scale was confirmed.

A region having high Ti and Si compositions, that is, nanoprecipitates (major axis length of ellipse: 100-300 nm) were regularly observed outside the cell, and it was because residual heat history caused when stacking each layer during the metal additive manufacturing process caused a significant heat treatment effect and became a driving force to precipitate composition-segregated Ti and Si into a secondary phase.

In the EDS results of FIG. 7, in the precipitated secondary phase, Ni, Ti, and Si elements were increased as compared with the outside of the precipitates, and as a result of lattice structure analysis by SAED, P6₃/mmc, a=4.79 Å, and c=8.12 Å were confirmed and an eta-Do₂₄ phase was precipitated in a nano size.

Specifically, a difference in the compositions inside and outside the precipitates in the example is shown in the following Table 3.

As confirmed in the following Table 3, a Mn content was 7.5 at % in the nanoprecipitates, which was lower than 10.5 at % outside the precipitates. In addition, a Co content was 7.5 at % in the nanoprecipitates, which was lower than 10.5 at % outside the precipitates. Meanwhile, a Ti content was 20 at % in the nanoprecipitates, which was lower than 5.5 at % outside the precipitates, and a Si content was 7.5 at % in the nanoprecipitates, which was higher than 0.5 at % outside the precipitates.

TABLE 3

| unit: at % | | | | | | | | |
|---|---|---|---|---|---|---|---|---|
| Alloy powder | | Outside precipitates | | | Inside precipitates | | | Equation |
| composition | | minimum | Average | maximum | minimum | Average | maximum | 4 (I-J)* |
| Fe | 65 | 46 | 53 | 60 | 35 | 37.5 | 40 | 3.0 |
| Ni | 15 | 15 | 20 | 25 | 15 | 20 | 25 | |
| Mn | 8 | 8 | 10.5 | 13 | 5 | 7.5 | 10 | |
| Co | 8 | 8 | 10.5 | 13 | 5 | 7.5 | 10 | |
| Ti | 3 | 3 | 5.5 | 8 | 15 | 20 | 25 | |
| Si | 1 | 0 | 0.5 | 1 | 5 | 7.5 | 10 | |
| Total | 100 | 80 | 100 | 120 | 80 | 100 | 120 | |

*In (I-J), I is an average value of Mn content (at %) outside precipitates, and J is a Mn content (at %) inside precipitates.

That is, a precipitation phase of a different type from a forging material was precipitated in a nano size small and evenly along the outside of the cell inside the matrix. This means that a heterostructure different from the heterostructure described above was formed at a 20 nm-500 nm scale.

Meanwhile, in Comparative Examples 1 to 3, a precipitation phase was not observed at 20 nm-500 nm scale.

As such, it was confirmed that the high-entropy alloy manufactured as in the example described above had three heterostructures, and the alloy manufactured in Comparative Examples 1 to 3 had no heterostructure as in the example.

### Experimental Example 4: Analysis of Tensile Test Results

The following Table 4 shows the results of a tensile test of the high-entropy alloys manufactured according to the example and the comparative examples of the present disclosure at room temperature (298 K). The tensile test was performed in a universal tensile tester (Instron, Instron 1361) under liquid nitrogen conditions.

TABLE 4

| | Room temperature (298 K) | | | | | |
|---|---|---|---|---|---|---|
| | | | Yield | | | |
| | | | strength × | Ultimate | | Ultimate tensile |
| | Yield | Uniform | uniform | tensile | Total | strength × total |
| | strength | elongation | elongation | strength | elongation | elongation |
| Classification | (MPa) | rate (%) | rate (MPa %) | (MPa) | rate (%) | rate (MPa %) |
| Example | 403 ± 3.9 | 32 ± 2 | 12896 | 1021 ± 4.5 | 46 ± 4.1 | 46966 |
| Comparative | 285 ± 9.3 | 39 ± 5 | 11115 | 618 ± 6.2 | 68 ± 13.8 | 42024 |
| Example1 | | | | | | |
| Comparative | 306 | 38.6 | 11811 | 694 | 57.3 | 39766 |
| Example2 | | | | | | |
| Comparative | 573 | 20 | 11460 | 728 | 34.5 | 25116 |
| Example3 | | | | | | |

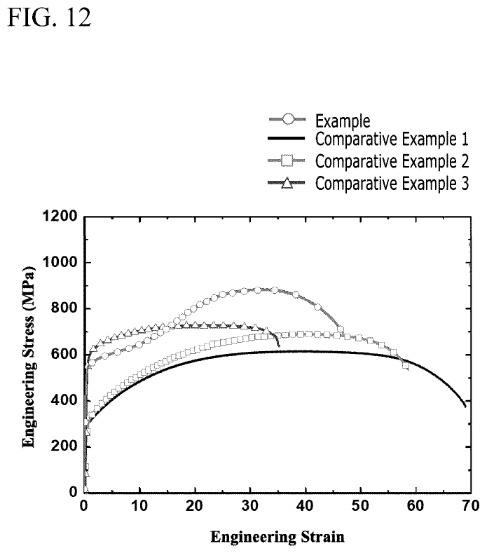

FIG. 12 is a graph showing strain and stress of the high-entropy alloys according to the example and the comparative examples of the present disclosure. The data marked with a circular label shows the date of the example, the data marked with a solid line shows the data of Comparative Example 1, the data marked with a quadrangular label shows the data of Comparative Example 2, and the data marked with a triangular label shows the data of Comparative Example 3.

In FIG. 12 and Table 4, it was confirmed that the example having three heterostructures had both excellent yield strength and tensile strength without performing separate additional strength improvement processes (such as age hardening heat treatment and rigid plasticity working), as compared with Comparative Examples 1 to 3. In addition, generally, when metal strength is high, an elongation rate is decreased (trade-off relationship), but the high-entropy alloy according to the present exemplary embodiment had excellent uniform elongation rate and total elongation rate in spite of its high strength. It was confirmed that a hetero reinforcement effect was expressed in multiple, so that a combination of mechanical properties was better than that of the comparative examples. Specifically, as confirmed in the “yield strength×uniform elongation rate (MPa %)” and the “ultimate tensile strength×total elongation rate (MPa %)” which are relative comparison indexes of a combination of mechanical properties in Table 4, the example had the yield strength×uniform elongation rate of 12896 MPa % which was increased by about 16.0% as compared with Comparative Example 1, and had the ultimate tensile strength×total elongation rate of 46966 MPa % which was increased by about 11.8% as compared with Comparative Example 1.

### Experimental Example 5: Analysis of Deformation Behavior

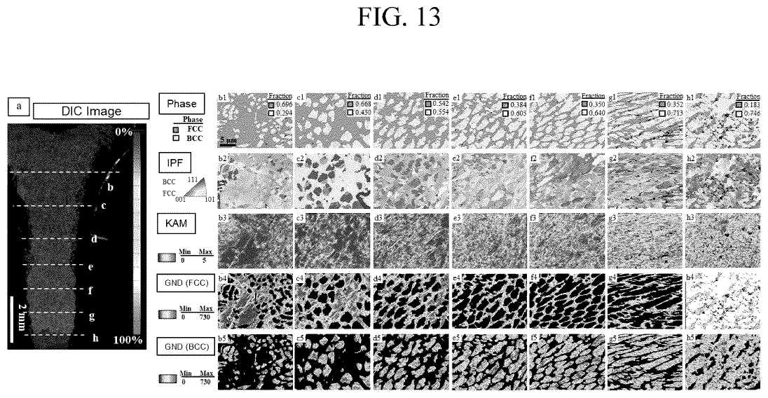

FIG. 13 is SEM-EBSD results in 500 nm-200 μm of the microstructure of the example obtained at different strains from each other using a DIC image. A tensile test was performed at a quasi-static deformation speed at 25° C.

Transformation/twinning-induced plasticity (TWIP/TRIP) behavior which is mainly expressed in an alloy having a metastable phase effectively improves ultimate tensile strength. At this time, the TWIP/TRIP behavior refers to twinning-induced phase transformation and deformation-induced phase transformation, respectively.

In the results of the tensile test at room temperature of the example in FIG. 12, since TRIP due to deformation was expressed, it was confirmed that ultimate tensile strength as well as yield strength was significantly excellent.

The c position of a. DIC Image in FIG. 13 was an about 15% deformed region. Figures c1 to c5 are SEM-EBSD results obtained in the c position of a. DIC Image. The size of the BCC martensite was significantly increased as compared with the b position, and in FCC, GND was rapidly accumulated around the BCC martensite. That is, FCC→BCC martensite TRIP was expressed due to deformation to increase strength. It is consistent with the results of a strain point at which engineering stress began to increase in the example of FIG. 12.

In the phase map and the IPF map, it was found that the region corresponding to the outside of the cell was TRIPed into the BCC martensite during deformation of FCC which is the metastable phase. As the strain was increased after the c point, more TRIPs were expressed to increase a martensite fraction, and thus, additional GND accumulation was increased in a similar trend, resulting in improvement of mechanical strength in all strains.

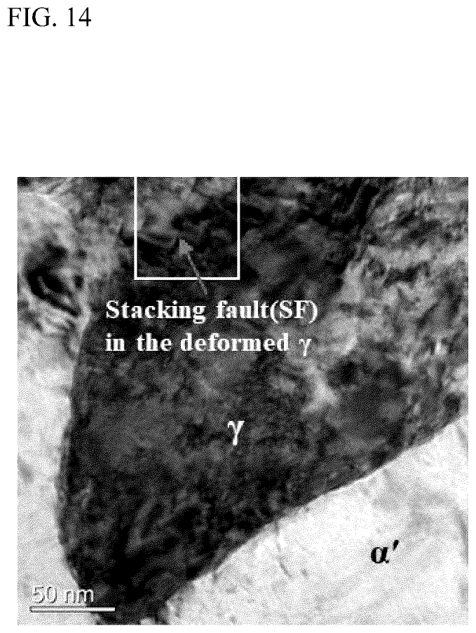

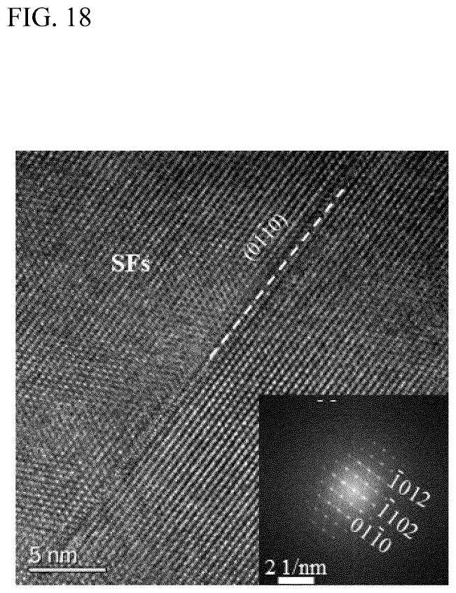

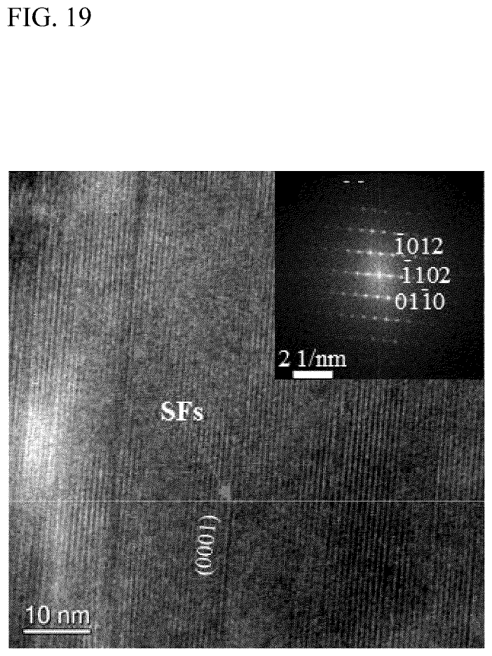

FIGS. 14 to 19 show results of TEM analysis of a 25% strained microstructure of the example at nano-scales of 500 nm or less.

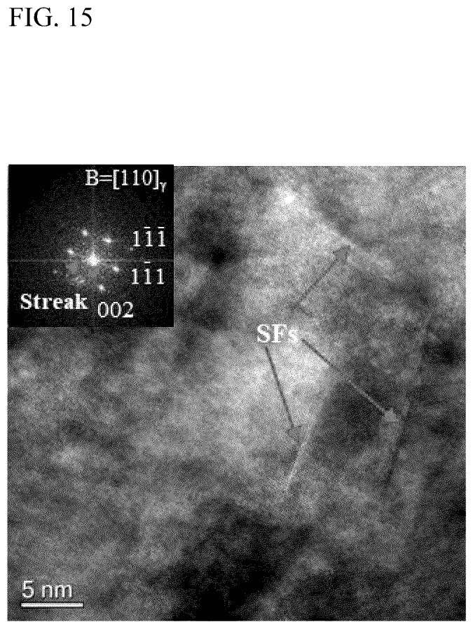

The FCC phase during deformation accepted most of the deformation and accepted many dislocations, and thus, when a certain threshold stress was exceeded, TRIP was expressed into the deformed BCC martensite phase. In addition, it was found in a BF image of FIG. 14 and HR-TEM image of FIG. 15 that in the high-entropy alloy of the example, stacking fault (SF) resulting from low phase stability occurred during deformation, and the produced SF accepted local deformation mismatch (arrow).

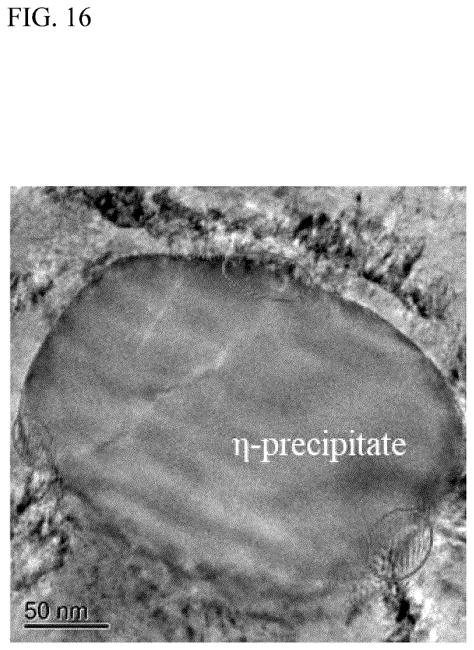

Referring to FIG. 16, a non-sized eta-Do24 phase was precipitated in the region outside the cell of the elementally segregated FCC phase, from the TEM results of the initial microstructure of the example. The precipitation phase generally interacts with dislocations during deformation depending on the size of the precipitation phase and interface coherency and is classified into a penetrable phase and a non-penetrable phase. Penetration means that dislocation moving by deformation crosses the precipitation phase.

The eta-Do24 precipitated in the example was nano-sized and a non-shearing precipitation phase which was hardly penetrable, and blocked movement of dislocations during deformation, which contributed to strength enhancement.

Referring to FIG. 16, it was confirmed that significant deformation was involved in the FCC phase around the eta-Do 24 phase and the accepted dislocations were accumulated along the periphery of the eta-Do 24 phase, and inconsistency between the locally increased strength and plastic deformation partially produced dislocations inside the eta-Do 24 phase (circle).

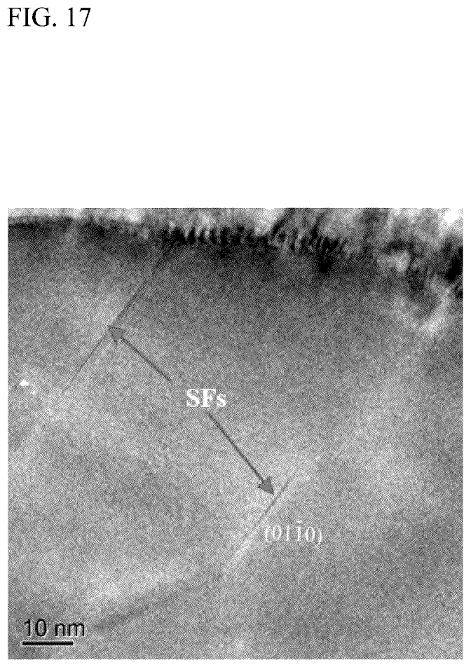

FIGS. 17 to 19 are HR-TEM results in which eta-Do24 phases were further enlarged. SF were formed in various directions inside the eta-Do24 phase like the FCC phase to accept deformation, which contributed to strength enhancement, and effectively inhibited dislocation movement inside the FCC phase as the non-shearing precipitation phase, which contributed to strength enhancement.

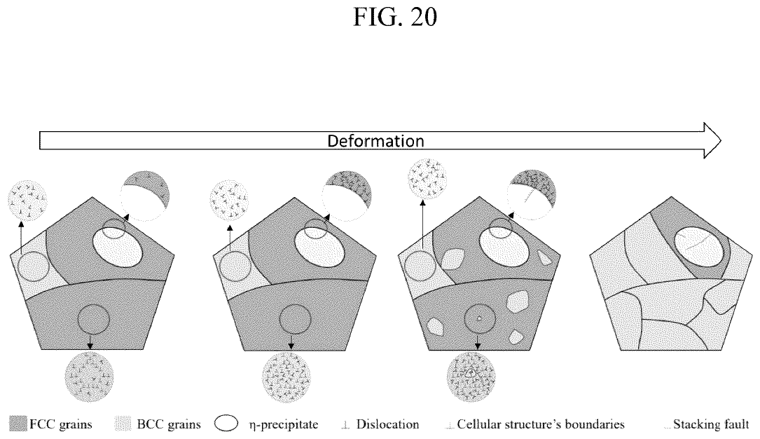

FIG. 20 is a schematic diagram of heterostructure and deformation behavior of the high-entropy alloy, which was drawn based on the analysis results of the microstructure of the example.

It was confirmed that at the beginning of the deformation, dislocations were accepted in a disorderly manner in the FCC phase outside the cell to increase strength, and then when the threshold stress was exceeded in more deformation steps, the TRIP behavior was expressed into the BCC martensite phase, which contributed to strength enhancement.

As deformation proceeded, it was confirmed that dislocation movement was inhibited around non-shearing nano-precipitation phase eta-Do24 to increase strength and dislocation was accumulated to form SF, which locally contributed to strength enhancement.

Therefore, it was confirmed from the comparison of the example with the comparative examples and the analysis of deformation behavior that the alloy according to the example had excellent yield strength and ultimate tensile strength from the three heterostructures without performing separate additional processes.

The present disclosure is not limited by the above exemplary embodiments and may be manufactured in various forms different from each other, and it may be understood that a person with ordinary skill in the art to which the present disclosure pertains may carry out the present disclosure in another specific form without modifying the technical idea or essential feature of the present disclosure. Therefore, it should be understood that the exemplary embodiments described above are illustrative and are not restrictive in all aspects.

What is claimed is:

1. A high-entropy alloy comprising:
a dual-phase structure of a columnar face-centered cubic (FCC) phase and an isometric body-centered cubic (BCC) phase;
a cell structure; and
precipitates.

2. The high-entropy alloy of claim 1, wherein:
the cell structure satisfies the following Equation 1:
$$2 \leq ( A - B ) \leq 10 \qquad [ Equation 1 ]$$
wherein A is a Ti content (at %) outside the cell, and
B is a Ti content (at %) inside the cell.

3. The high-entropy alloy of claim 1, wherein:
the BCC phase is a martensite phase which is a phase formed along a dendrite solidification structure inside FCC phase grains.

4. The high-entropy alloy of claim 1, wherein:
the high-entropy alloy includes: 5 to 25 at % of Ni, 2.5 to 15.0 at % of Mn, 2.5 to 15.0 at % of Co, 0.25 to 5.0 at % of Ti, 0.25 to 5.0 at % of Si, a remainder of Fe, and other impurities, based on 100 at % of the entire high-entropy alloy.

5. The high-entropy alloy of claim 1, wherein:
the cell structure includes: 5.0 to 25.0 at % of Ni, 2.5 to 15.0 at % of Mn, 2.5 to 15.0 at % of Co, 0 to 7.5 at % of Ti, 0 to 5.0 at % of Si, a remainder of Fe, and other impurities, based on 100 at % of the entire cell structure.

6. The high-entropy alloy of claim 1, wherein:
the precipitates include: 10.0 to 30.0 at % of Ni, 2.5 to 15.0 at % of Mn, 2.5 to 15.0 at % of Co, 10.0 to 30.0 at % of Ti, 1.0 to 15.0 at % of Si, a remainder of Fe, and other impurities, based on 100 at % of the entire precipitates.

7. The high-entropy alloy of claim 1, wherein:
the cell structure satisfies the following Equations 2 and 3:
$$5 \leq ( C - D ) \leq 30 \qquad [ Equation 2 ]$$
wherein C is a Ni content (at %) outside the cell, and
D is a Ni content (at %) inside the cell,
$$2 \leq ( E - F ) \leq 10 \qquad [ Equation 3 ]$$
wherein E is a Co content (at %) outside the cell, and
F is a Co content (at %) inside the cell.

8. The high-entropy alloy of claim 1, wherein:
the precipitates satisfy the following Equations 4 and 5:
$$2 \leq ( I - J ) \leq 10 \qquad [ Equation 4 ]$$
wherein I is a Mn content (at %) outside the precipitates, and
J is a Mn content (at %) inside the precipitates,
$$2 \leq ( K - L ) \leq 10 \qquad [ Equation 5 ]$$
wherein K is a Co content (at %) outside the precipitates, and
L is a Co content (at %) inside the precipitates.

9. The high-entropy alloy of claim 1, wherein:
the precipitates satisfy the following Equation 6:
$$5 \leq ( M - N ) \leq 35 \qquad [ Equation 6 ]$$
wherein M is a Ti content (at %) outside the precipitates, and
N is a Ti content (at %) inside the precipitates.

10. The high-entropy alloy of claim 1, wherein:
the precipitates satisfy the following Equation 7:
$$2 \leq ( O - P ) \leq 20 \qquad [ Equation 7 ]$$
wherein O is a Si content (at %) outside the precipitates, and
P is a Si content (at %) inside the precipitates.

11. The high-entropy alloy of claim 1, wherein:
the precipitates are oval shaped and have a major axis length of 50 to 500 nm.

12. The high-entropy alloy of claim 1, wherein:
a precipitation phase of the precipitates is Fe₂SiTi and Ni₃Ti.

13. The high-entropy alloy of claim 1, wherein:
a phase fraction of the FCC phase is 85% or more, based on 100% of the phase fraction.

14. The high-entropy alloy of claim 1, wherein:
an absolute value of a difference in geometrically necessary dislocations (GND) between the BCC phase and the FCC phase is 10×10¹² mm⁻² or more.

15. The high-entropy alloy of claim 1, wherein:
when tensile strain is applied to the high-entropy alloy,
deformation-induced phase transformation from the FCC into the BCC occurs.

16. The high-entropy alloy of claim 1, wherein:
the high-entropy alloy has a yield strength of 300 MPa or more.

17. The high-entropy alloy of claim 1, wherein:
the high-entropy alloy has an ultimate tensile strength of 700 MPa or more.

18. A method of manufacturing a high-entropy alloy, the method comprising:
manufacturing raw metal into alloy powder;
supplying energy by irradiating the alloy powder with a laser beam to melt the alloy powder; and
stacking the molten powder to manufacture an alloy,
wherein the manufactured high-entropy alloy includes a double-phase structure of a columnar face-centered cubic (FCC) phase and an isometric body-centered cubic (BCC) phase, a cell structure, and precipitates.

19. The method of manufacturing a high-entropy alloy of claim 18, wherein:
the alloy powder manufactured in the manufacturing of raw metal into alloy powder has D50 in a range of 45 to 95 μm, and in a particle size distribution of the powder, a volume fraction of powder particles corresponding to D40 to D60 is 30 vol % or more.
